(19) United States
(12) Patent Application Publication
(10) Pub. No.: US 2009/0122278 A1
(43) Pub. Date: May 14, 2009

(54) NON-SPECULAR FOLDING MIRROR AND A SYSTEM OF USING THE SAME

(75) Inventors: Leif Stefan Kirschenbaum, Napa, CA (US); Regis Grasser, Mountain View, CA (US); Steven Werner Gensler, San Jose, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/938,959

(22) Filed: Nov. 13, 2007

(51) Int. Cl. G03B 21/28; G02B 5/02; G02B 5/09; G02B 5/18; G02B 5/08; G02B 13/20; G02B 7/182

(52) U.S. Cl. 353/98; 359/572; 359/599; 359/851

(57) ABSTRACT

A non-specular reflective optical element comprises a reflective surface. A beam of incident light can be reflected such that the reflective angle may or may not be the same as the incident angle. In an exemplary application of a rear projection system, the non-specular folding mirror is used to project the modulated light from a light valve onto a translucent screen.

### TECHNICAL FIELD OF THE DISCLOSURE

The technical field of this disclosure relates to the art of non-specularly reflecting optical elements; and more particularly to the art of non-specular reflective folding mirrors for use in display systems.

### BACKGROUND OF THE DISCLOSURE

A typical specular optical element reflects a beam of incident light such that the reflected angle (the angle between the reflected light and the normal of the reflective surface) is the same as the incident angle (the angle between the incident light beam and the normal direction of the reflective surface). In practical applications, a specular optical element is expected to be properly aligned to the incident light and the target toward which the reflected light travels. In some optical systems, such specular reflection causes limitations to the optical system design.

For example, specular folding mirrors are often used in current rear projection systems folding light from an array of light valve pixels of a light valve onto a translucent screen. Due to the specular reflection, system components, such as illumination systems provided for generating illumination light, light valves, specular folding mirrors, and other internal optical elements for directing the illumination light, need to be arranged to satisfy the specular reflection and to satisfy that the folded light creates a desired illumination field at the location of the translucent screen. As a consequence, the specular folding mirror, as well as the associated optical design of other components, may occupy a large space in rear display systems. In other words, reducing the size of rear projection systems to provide compact or portable systems will be significantly limited.

### SUMMARY

In view of the foregoing, a reflective folding mirror having a non-specular reflection property is provided herein. The non-specular reflective folding mirror reflects an incident light beam such that the reflective angle is not the same as the incident light angle.

In one example, an imaging system is disclosed herein. The system comprises: a light valve comprising an array of individually addressable pixels; and a non-specular reflective optical element comprising a reflective surface disposed between the light valve and a display target for reflecting light from the light valve onto the display target.

In another example, a projector is disclosed herein. The projector comprises: a light valve comprising an array of individually addressable pixels; and a reflective folding mirror disposed between the light valve and a display target, wherein the reflective folding mirror comprises a reflective surface for projecting light from the light valve onto the display target; and wherein the reflective surface comprises: a set of grooves each having a reflective facet.

In yet another example, a projector is disclosed herein. The projector comprises: a light valve having an array of individually addressable pixels; and a folding mirror disposed between the light valve and a display target, wherein the folding mirror comprises a Bragg grating such that a visible light beam incident to the folding mirror at an incident angle is capable of being reflected by the Bragg grating into a reflected light beam having a reflection angle that is different from the incident angle.

### BRIEF DESCRIPTION OF DRAWINGS

FIG. 1 schematically illustrates an exemplary non-specular folding mirror;

FIG. 2a schematically illustrates an exploded view of a portion of the non-specular folding mirror in FIG. 1;

FIG. 2b schematically illustrates a cross-sectional view of the non-specular folding mirror in FIG. 1;

FIG. 2c schematically illustrates another exemplary non-specular folding mirror with curved ridges;

FIG. 2d schematically illustrates another exemplary non-specular folding mirror with inward curved reflective facets;

FIG. 2e schematically illustrates another exemplary non-specular folding mirror with outward curved reflective facets;

FIG. 3a and FIG. 3b schematically illustrates an exemplary Bragg grating that can be used in a non-specular folding mirror;

FIG. 3c schematically illustrates the refractive index variation of the Bragg grating in FIG. 3a;

FIG. 4a schematically illustrates an exemplary non-specular folding mirror having a Bragg grating on a surface of a substrate;

FIG. 4b schematically illustrates an exemplary non-specular folding mirror having a Bragg grating formed in the body of a substrate;

FIG. 5 schematically illustrates a cross-sectional view of a non-specular folding mirror having a plurality of Bragg gratings formed on separate substrates that are laminated together;

FIG. 6 schematically illustrates a cross-sectional view of a non-specular folding mirror having a plurality of Bragg gratings formed on single substrate;

FIG. 7 schematically illustrates a cross-sectional view of a non-specular folding mirror having a plurality of Bragg gratings formed on a surface of single substrate;

FIG. 8 schematically illustrates an exemplary rear-projection system employing a non-specular folding mirror; and

FIG. 9 schematically illustrates an exemplary micromirror device that can be used in the light valve in the rear-projection system in FIG. 8.

### DETAILED DESCRIPTION OF SELECTED EXAMPLES

Disclosed herein is a non-specularly reflecting optical element that comprises a reflective surface. A beam of incident light can be reflected by the reflective surface such that the reflected angle is not the same as the incident angle.

The non-specular optical element and systems using the same will be discussed in the following with reference to selected examples. It will be appreciated by those skilled in the art that the following discussion is for the purpose of demonstration, and should not be interpreted as a limitation. Many other variations within the scope of this disclosure are also applicable.

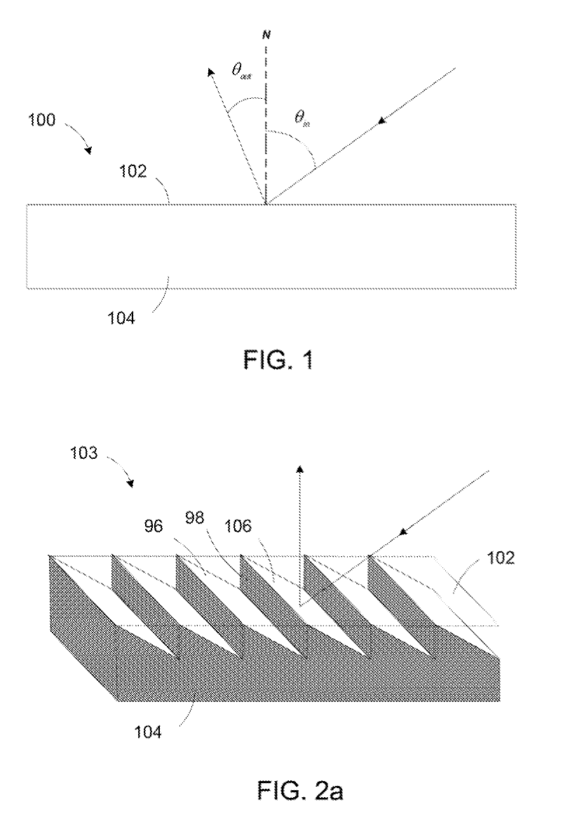

Referring to the drawings, FIG. 1 schematically illustrates an exemplary non-specular optical element, which is a non-specular reflective folding mirror (100). The non-specular folding mirror comprises a reflective surface (102) on a substrate (104). The reflective surface is capable of reflecting a beam of incident light such that the reflected angle, θₒᵤₜ is not be the same as the incident angle θᵢₙ, wherein the reflected angle is defined as the angle between the reflected light and the normal direction N of the reflective surface, and the incident angle is defined as the angle between the incident light and the normal direction. As will be seen in the following, the reflective surface (102) may be composed of fine structures, such as reflective facets. In this instance, the reflective surface (102) is a substantially planar reflective surface that best approximates the cumulative profiles of the fine structures.

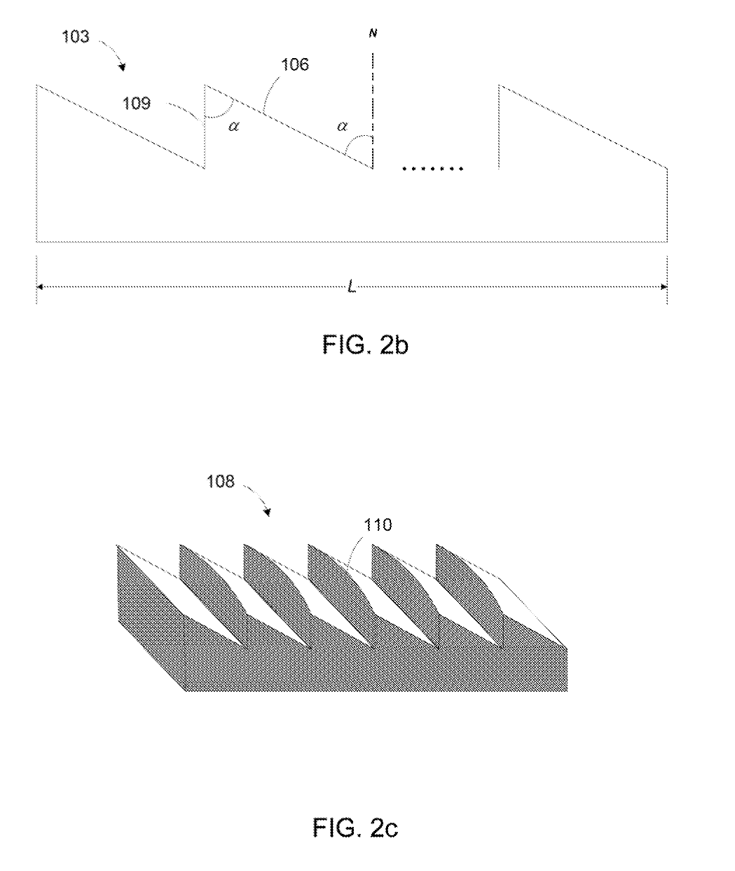

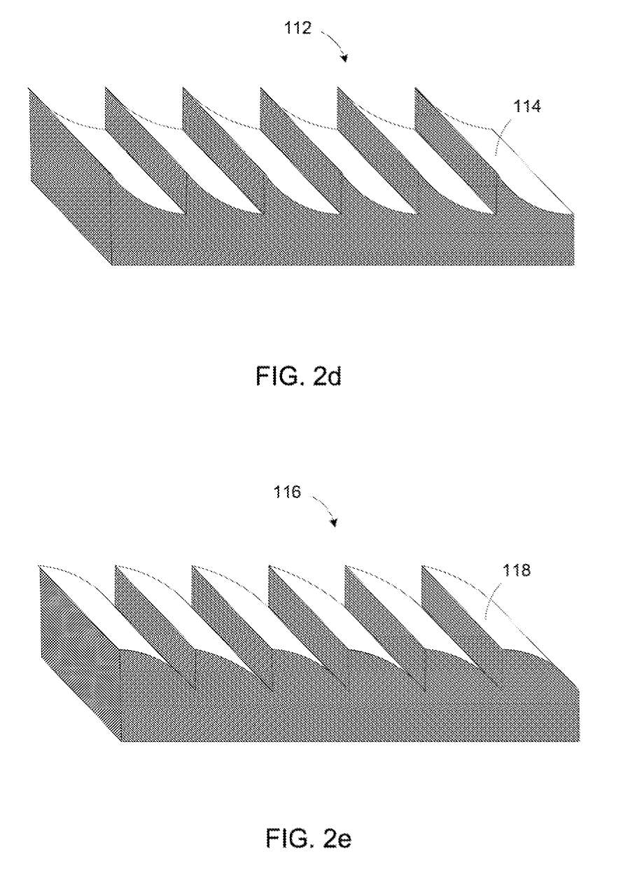

FIG. 2a schematically illustrates an exploded view of a portion of an exemplary non-specular folding mirror (103). Referring to FIG. 2a, a series of reflective facets (e.g. facet 106) is deployed along the length of folding mirror 103. The reflective facets are interconnected such that adjacent reflective facets (e.g. facets 106 and 96) are connected by a connection portion (e.g. connection portion 98) that is not parallel to either one of the adjacent reflective facets (e.g. reflective facets 96 and 106). The connection portion, which can be a reflective or non-reflective area, may have an angle to each one of the adjacent reflective facets, wherein the angle is not zero or 180 degrees. Specifically, the normal direction of the connection area (e.g. 98) is not parallel to perpendicular to the normal direction of either one of the adjacent reflective facets (e.g. 106 and 96) that are connected by the connection portion. In one example, each reflective facet is recessed from reflective surface 102; and may have an acute angle to the reflective surface.

In the example as illustrated in FIG. 2a, a number of triangular-shaped fine structures are periodically formed on a surface of a substrate, such as substrate 104 in FIG. 1. Each triangular fine structure comprises a reflective facet, such as reflective facet 106. The reflective facets can be specular mirrors such that incident light beams to the reflective facets can be non-diffractively reflected in compliance with the specular reflection rule, wherein the incident angle is equal to the reflected angle. In this example, each reflective facet is substantially planar; and the facets of the fine structures are substantially parallel to each other. In other examples which will be discussed afterwards with reference to FIG. 2d and FIG. 2e, the reflective facets can be curved reflective surfaces. In still other examples, the reflective facets may not be parallel to each other. The reflective facets may or may not be equally spaced apart. In one example, a group of reflective facets can be deployed along the reflective surface (102) of the non-specular mirror. The facets in each group may be uniformly arranged—such as equally spaced away from each other and/or substantially parallel to each other; while different groups can be arranged in any desired ways that can be independent from the arrangements of the reflective facets in each group. Alternatively, reflective facets in an individual group may not be parallel to each other.

The triangular fine structures together form a saw-tooth profile, which will be better illustrated in FIG. 2b. A straight plane that best approximates the saw-tooth profile can be defined as the reflective surface (i.e. surface 102) of the non-specular folding mirror.

Depending upon different applications, the triangular fine structures, especially the reflective facets of the triangular fine structures, can be configured in a wide range of ways. In the example as illustrate in FIG. 2a, each triangular fine structure has single reflective facet; and the reflective facet is not parallel to the reflective surface (102). The angle between the reflective facet and reflective surface 102 can be any suitable value, depending upon specific applications. For maximizing the area of the reflective facet in each triangular fine structure, the other two facets of the triangular fine structure are disposed such that one of the other two facets is placed substantially vertically, and the other facet is facing the substrate. The geometric configuration of the non-specular folding mirror is better illustrated in FIG. 2b.

Referring to FIG. 2b, a cross-sectional view of the non-specular folding mirror in FIG. 2a is schematically illustrated, wherein the cross-sectional view is taken along a line perpendicular to the ridges of the triangular fine structures. The non-specular folding mirror (103) has a length L measured from the ridge of the triangular fine structure at one end of the non-specular folding mirror to the valley of the last triangular fine structure located at the opposite end of the non-specular folding mirror. Depending upon different applications, L can be any suitable values. For example in rear-projection systems, L can be around H/cos(ω), wherein H is the height of the translucent screen; and ω is the angle between the non-specular folding mirror and the translucent screen, as illustrated in FIG. 8. Other values are also applicable depending upon the specific system and optical design in which the folding mirror is employed.

Each triangular fine structure comprises a specular reflective facet, such as facet 106 for non-diffractively reflecting the incident light. The reflective facets are substantially parallel to each other. The reflective facet has an angle α to the normal direction N of the non-specular folding mirror, as defined in FIG. 1. Angle α can be any suitable values from 0 to 90 degrees excluding 0 and 90 degrees, such as from 10 to 80 degrees, from 20 to 70 degrees, and from 30 to 60 degrees. To maximize the area of the reflective facet and the filling factors of the reflective facet, which is defined as the ratio of the total area of the reflective facets over the area of the reflective surface (102) of the non-specular folding mirror, side surface 109 can be substantially vertical (parallel to the normal direction N). It is noted that surface 109 may or may not be reflective.

The triangular fine structures can be continuously formed—that is, the valley of one triangular fine structure is substantially connected to the ridge of the adjacent triangular fine structure. In the example illustrated in FIG. 2a and 2b, the triangular fine structures are substantially identical; and are periodically disposed. This is only one of many possible examples. Other variations are also applicable. For example, the triangular fine structures on a non-specular folding mirror may not be identical. A non-specular folding mirror may comprise multiple groups of triangular fine structure or even non-triangular fine structures. One group may have triangular fine structures with the reflective facets at one angle to the normal direction N; while another group may have triangular fine structures with reflective facets being an another angle to the normal direction N. The fine structures (triangular or non-triangular) in different groups may be deployed in any desired ways. For example, a fine structure of one group can be disposed at a location between two adjacent fine structures in another group. In another example, a small number of fine structures in one group can be dispersed within the area in which a large number of fine structures in another group are deployed in a specific pattern. Other configurations are also applicable.

Other than forming the triangular fine structures with substantially straight ridges and planar reflective facets as discussed above, the triangular fine structures can be configured to have many other forms to accomplish other desired functions. For example, ridges and/or reflective facets can be curved so as to generate desired far-field illumination patterns, such as a broader illumination field compared to non-specular folding mirrors with straight ridges and/or planar reflective facets.

FIG. 2c schematically illustrates an exemplary non-specular folding mirror with curved ridges. Referring to FIG. 2c, non-specular folding mirror 108 comprises a number of triangular fine structures. The triangular structures each comprises a reflective facet such as that discussed above with reference to FIG. 2a. Unlike that in FIG. 2a, facets of the triangular fine structures are curved. The curvature can be concave or convex along the length of the facets. It is noted that all facets can be curved; while facets at different locations may or may not be curved along the same direction or their degree of curvature may vary. Facets curved in the same and different directions can be arranged in any suitable ways. In another example, some facets are curved; and some other facets are not curved (substantially straight). The curved facets can be disposed in any suitable ways relative to the substantially straight facets. For example, a curved facet can be located between two adjacent substantially curved facets. In yet another example, a non-specular folding mirror may be comprised of triangular find structures with substantially straight facets and facets curved in different directions. Arrangements of fine structures can be in any suitable ways. In one example, some ridges are curved; and some other ridges are not curved (substantially straight). And the curved ridges can be disposed in any suitable ways relative to the substantially straight ridges. For example, a curved ridge can be located between two adjacent substantially curved ridges. In yet another example, a non-specular folding mirror may comprise triangular fine structures with substantially straight ridges and ridges curved in different directions. Arrangements of fine structures can be in any suitable ways.

In addition to the curved ridges, the reflective facets can be curved inward or outward perpendicular to the length of the facets as illustrated in FIG. 2d and FIG. 2e. Referring to FIG. 2d, non-specular folding mirror comprises a number of triangular fine structures. Each triangular fine structure comprises a curved reflective facet, such as facet 114. In this example, the reflective facet is curved inward so as to form a concave reflective surface. The reflective facets are substantially parallel to each other. By adjusting the curvature of the reflective facets, the reflective light can accomplish different illumination fields, which provides flexibility in optical design of the system. The reflective facets may not all be curved. Some of the reflective facets may be curved; while some may be substantially straight planar. In this instance, the straight planar reflective facets and the curved reflective facets can be arranged in any suitable orders.

Other than concave reflective facets, the non-specular folding mirror may comprise convex reflective facets, wherein the reflective facets are curved outward, as schematically illustrated in FIG. 2e.

Referring to FIG. 2e, non-specular folding mirror 116 comprises a number of triangular fine structures. Each triangular fine structure comprises a reflective facet that is curved outward, such as facet 118. The reflective facets are substantially parallel to each other. By adjusting the curvature of the reflective facets, the reflective light can accomplish different illumination fields, which provides flexibility in optical design of the system. The reflective facets may not all be curved. Some of the reflective facets may be curved; while some may be substantially straight planar. In this instance, the straight planar reflective facets and the curved reflective facets can be arranged in any suitable orders.

In the above examples, as well as other examples within the scope of this disclosure, the reflective facets can comprise any suitable reflective materials, such as single materials (e.g. Au, Ag, Cu, and Al), metal alloys, and metal compounds. The reflective material can be a thin film coated on a surface, such as a surface of the fine structure. The fine structures, as well as the substrate, can be composed of any suitable materials, such as transmissive or non-transmissive materials. For example, the fine structure and the substrate can be glass, quartz, sapphire, polymers, plastics, or many other suitable materials.

The non-specular folding mirrors as discussed above can be fabricated in many ways. As an example, a substrate of a selected material is provided. Fine structures can then be formed on a surface of the substrate by many ways, such as stamping, extruding, patterning and etching, micromachining, or other ways, such as mechanical cutting. The obtained fine structures can be polished so as to obtain clean surfaces, especially surface on which the reflective facets are to be formed. A selected reflective material can then be deposited on the desired surfaces of the fabricated fine structures so as to obtain desired reflective facets.

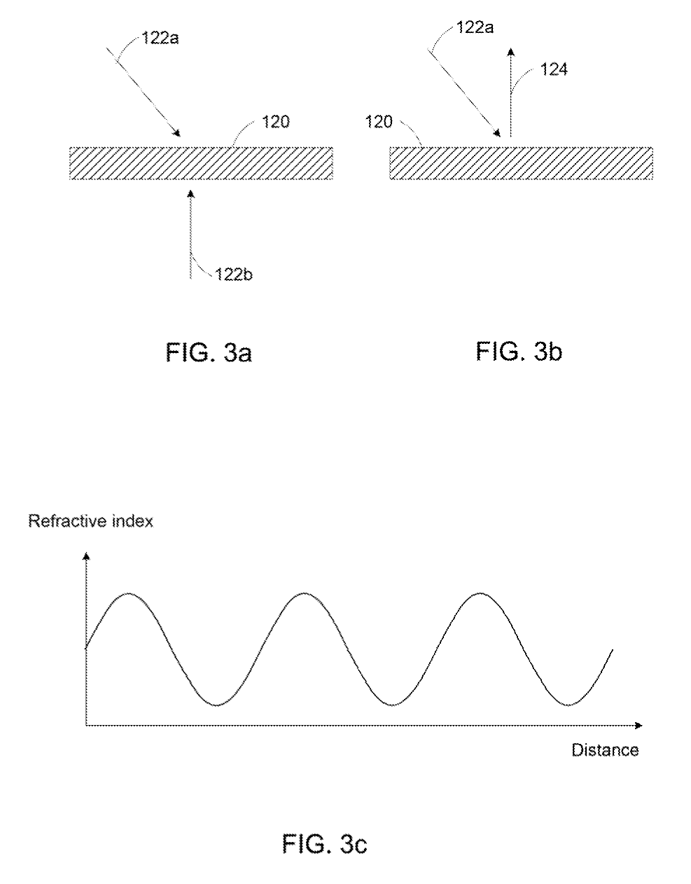

Other than accomplishing non-specular reflection by reflective facets as discussed above with reference to FIG. 2a through FIG. 2e, a non-specular reflection can be accomplished by other methods, one of which is Bragg gratings. Specifically, a non-specular folding mirror may comprise a Bragg grating for reflecting incident light such that the reflected angle may or may not be the same as the incident angle. FIG. 3a schematically illustrates an exemplary Bragg grating.

Referring to FIG. 3a, Bragg grating 120 is a hologram that comprises a periodic perturbation of a holographic material with the period close to the wavelength of a specific incident light beam. The holographic material can be any suitable materials, such as DiChromated Gelatin (DCG), holographic silver halide emulsions, photosensitive materials (e.g. photopolymers, photo-crosslinkers, photothermlplastics, photochromatics, photodichronics, photosensitive glass or photosensitive materials that are transmissive to light with specific wavelengths), ferroelectric crystals, gelatin materials, polyvinyl carbazole (PVK), DMP 128 (a formulation of lithium acrylate in combination with a branched polyethylenimine), and any suitable combinations thereof.

Bragg grating 120 can be fabricated by illuminating a suitable holographic material with interfering light beams 122a and 122b that are converged at the holographic material. The interfering light beams 122a and 122b generate fringes; and certain areas of the holographic material are exposed by the fringes. As a consequence, the exposed areas of the holographic material change their refractive indices to a different value than non-exposed areas of the holographic material, resulting in a refractive index variation over the holographic material. The index variation can be in many forms, such as a sinusoidal (as schematically illustrated in FIG. 3c) or equivalences or other forms, such as square waves. FIG. 3c schematically illustrates an exemplary index variation with a sinusoidal

Bragg grating 120 can be used to non-specularly reflecting incident light beam, as schematically illustrated in FIG. 3b. Referring to FIG. 3b, when incident light beam 122a has substantially the same wavelength as that used in creating the Bragg grating (as illustrated in FIG. 3a), the incident light is reflected non-specularly such that reflected light 124 has a reflected angle different from the incident angle of light beam 122a.

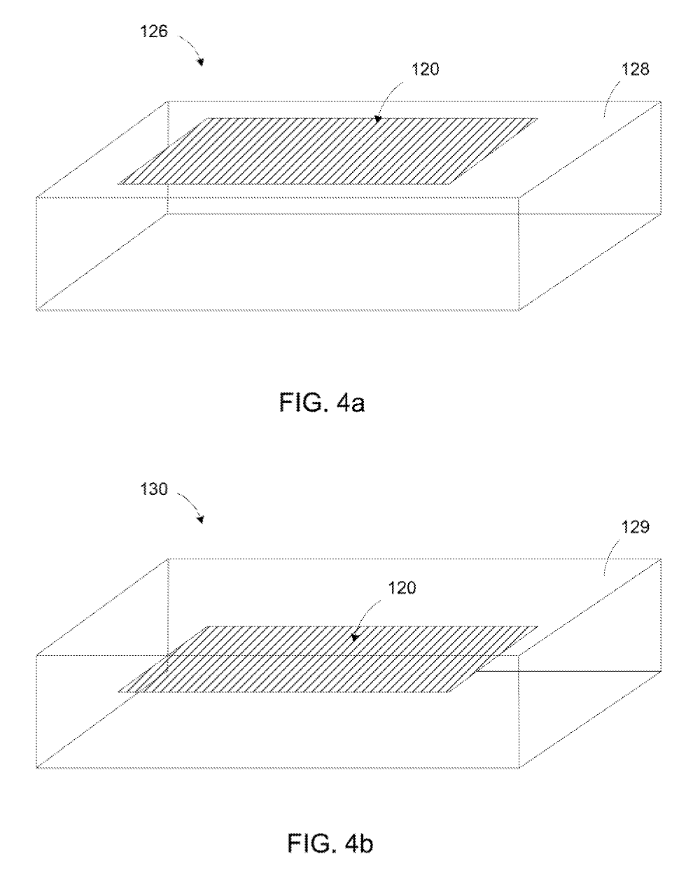

By converging the writing light beams (e.g. light beams 122a and 122b) at different locations of a substrate comprising a selected holographic material, a Bragg grating can be formed on the surface of the substrate or within the body of the substrate as schematically illustrated in FIG. 4a and FIG. 4b.

Referring to FIG. 4a, substrate 128 comprises a selected holographic material as discussed above. By converging interfering writing light beams (e.g. beams 122a and 122b in FIG. 3a) substantially at the surface of substrate 128, Bragg grating 120 can be formed thereby on the surface of substrate 128.

Referring to FIG. 4b, substrate 129 comprises a selected holographic material as discussed above; and is transmissive to the interfering writing beams. By converging the writing beams at a pre-defined location within the body of substrate 129, Bragg grating 120 can thus be formed within the body of substrate 129.

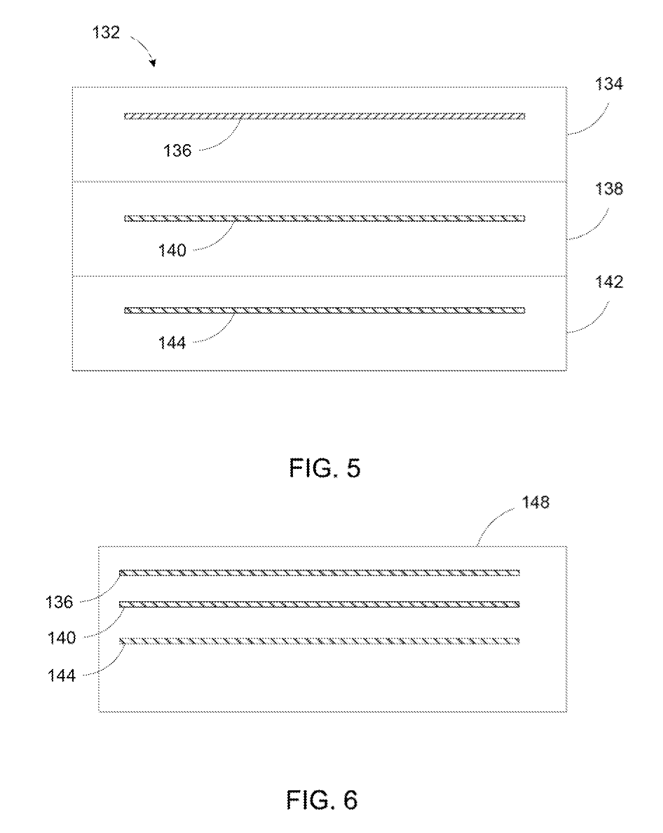

Because the non-specular reflection of a particular Bragg grating is limited for the incident light beam with substantially the same wavelength as the light beam used in inscribing the Bragg grating, multiple Bragg gratings created by light beams of different wavelengths are expected for non-specularly reflecting light beams with different colors (wavelengths). This is of particular importance in display systems wherein light beams of different colors (e.g. red, green, blue, white, yellow, cyan, magenta, or any combinations thereof) are used for displaying color images. Using single reflective folding mirror capable of non-specularly reflecting light beams of different wavelengths is, therefore, of great advantage. It is noted that the period and/or the orientation of single Bragg grating may vary smoothly, which can be of importance when the incident light beam has spatial angular extend (e.g. a cone of incident light) and components of the incident light are incident to the single Bragg grating at slightly different angles. Accordingly, it is preferred (though not required) that, the period and/or the orientation of the Bragg grating may vary within a suitable range corresponding to the angular extension of the incident light. Bragg gratings of different wavelength properties can be deployed in many ways. In one example, different Bragg gratings can be formed on separate substrates; and the separate substrates can be laminated into a substrate assembly, as schematically illustrated in FIG. 5.

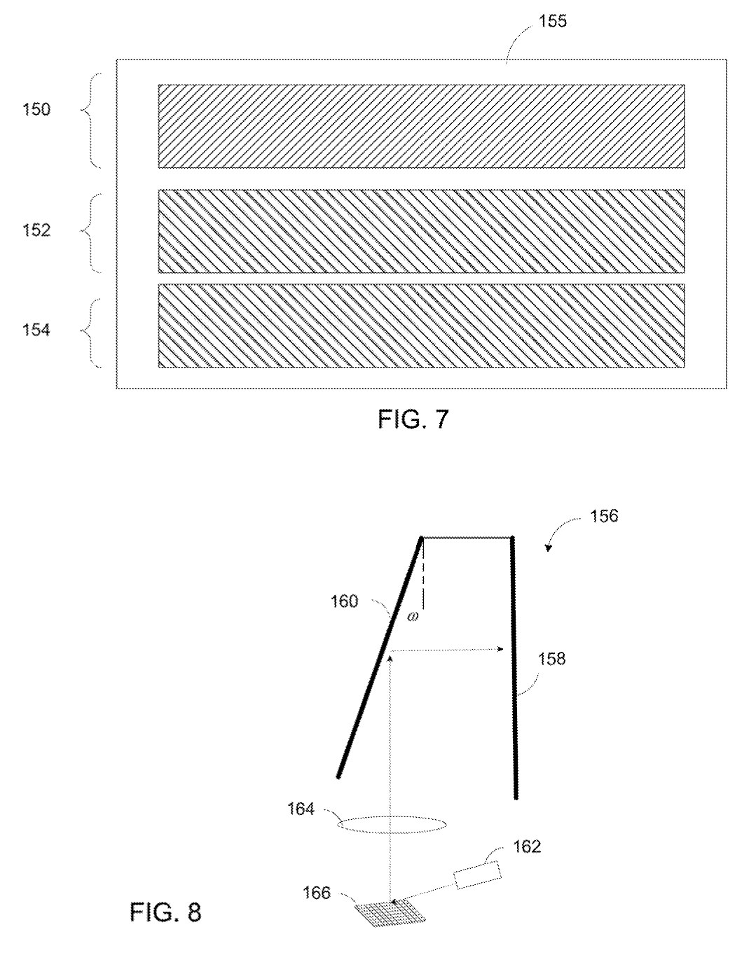

Referring to FIG. 5, Bragg gratings 136, 140, and 144 with different wavelength properties are formed on separate substrates 134, 138, and 142. Each Bragg grating can be formed in the same way as discussed above with reference to FIG. 4b. The separate substrates 134, 138, and 142 can be laminated into substrate assembly 132; and the substrate 132 can be used as a non-specular folding mirror or a component of a non-specular folding mirror. Alternatively, the multiple Bragg gratings can be formed within the body of single substrate, as schematically illustrated in FIG. 6.

Referring to FIG. 6, Bragg gratings 136, 140, and 144 of different wavelength properties are formed within the body of substrate 148. The substrate (148) can be used as a non-specular folding mirror or a component of a non-specular folding mirror.

Instead of forming the multiple Bragg gratings within the body (or bodies) of a substrate (or multiple substrates), the Bragg gratings can be formed on a surface of a substrate as schematically illustrated in FIG. 7.

Referring to FIG. 7, Bragg gratings 150, 152, and 154 of different wavelength properties are formed on a surface of substrate 155 with substrate 155 comprising a selected holographic material as discussed above. Each Bragg grating can be formed by the same method as discussed above with reference to FIG. 4a. Different Bragg gratings are created by different pairs of interfering writing beams; and can be created simultaneously or separately.

The non-specular folding mirror as discussed above has many applications, one of which is display system, such as rear projection systems using light valves. An exemplary rear projection system employing a non-specular folding mirror is schematically illustrated in FIG. 8.

Referring to FIG. 8, rear-projection system 156 comprises illumination system 162, light valve 166, optical element 164, non-specular folding mirror 160, and translucent screen 158.

Illumination system provides illumination light that can be monochromatic light or a combination of colors that are selected from red, green, blue, yellow, cyan, magenta, white, and any other desired colors. The illumination system may employ any desired illuminators, such as traditional illuminators (e.g. arc lamps), solid-state illuminators (e.g. lasers and light-emissive-diodes), and many other narrow-banded illuminators. Accordingly, the illumination light can be phase-coherent or phase incoherent.

The illumination light from the illumination system is directed to light valve 166 that comprises an array of individually addressable pixels. The light valve can be a spatial light modulator (e.g. a micromirror-based spatial light modulator, a liquid-crystal display panel (LCD), a liquid-crystal-on-silicon (LCOS) based spatial light modulator, a silicon crystal reflective display panel (sXRD), and an interferometric modulator, etc.) and other types of light valves, such as self-light emitting light valves (e.g. organic light-emitting diode displays and plasma panels). When the light valve is a self-light emitting light valve, the illumination system may not be necessary.

The light valve modulates the incident light based on a set of image data (e.g. bitplane data) derived from the image to be projected. The modulated light is then directed to the non-specular folding mirror (160) through optical element(s) 164. The non-specular folding mirror (160) projects the modulated light onto the translucent screen (158) so as to form the image on the translucent screen.

Because the folding mirror is a non-specular folding mirror that can be any of the above discussed examples or other examples not discussed above but within the scope of this disclosure, the light valve, non-specular folding mirror, and the illumination system (if provided) can be arranged in a much wider range of ways compared to the projection system with the folding mirror being replaced by a specular folding mirror. In particular, the angle ω between the non-specular folding mirror and the translucent screen can be adjusted to satisfy other preferences, such as the depth of the rear-projection system. In one example, angle ω between the non-specular folding mirror and the translucent screen can be from 60 degrees or less, 45 degrees or less, 30 degrees or less, 25 degrees or less, 20 degrees or less, or 10 degrees or less so as to reduce the depth of the rear-projection system.

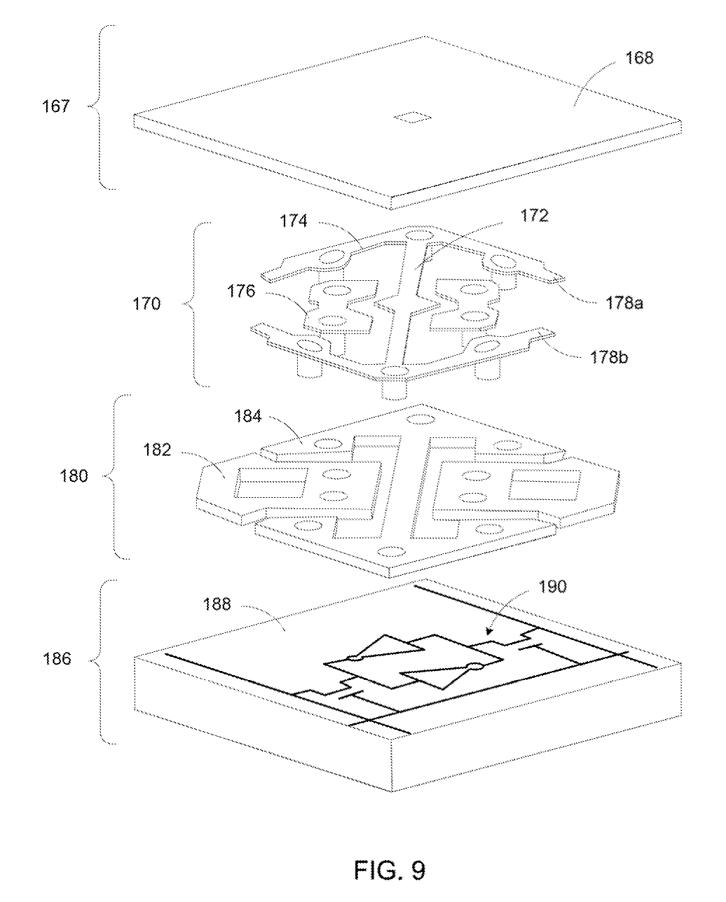

As discussed above, the light valve may be a spatial light modulator comprising an array of individually addressable micromirror devices. An exemplary micromirror device is schematically illustrated in FIG. 9.

Referring to FIG. 9, the micromirror device comprises substrate layer 186 in which substrate 188 is provided. Substrate 188 can be any suitable substrates, such as semiconductor substrates, on which electronic circuits (e.g. circuits 190) can be formed for controlling the state of the micromirror device.

Formed on substrate layer 186 can be electrode pad layer 180 that comprises electrode pad 182 and other features, such as electronic connection pad 184 that electrically connects the underlying electronic circuits to the above deformable hinge and mirror plate. Hinge layer 170 is formed on the electrode pad layer (180). The hinge layer comprises deformable hinge 172 (e.g. a torsion hinge) held by hinge arm 174 that is supported above the substrate by hinge arm posts. Raised addressing electrodes, such as electrode 176 is formed in the hinge layer (170) for electrostatically deflecting the above mirror plate. Other features, such as stopper 178a and 178b each being a spring tip, can be formed in the hinge layer (170). Mirror plate layer 167, which comprises reflective mirror plate 168 attached to the deformable hinge by a mirror post, is formed on the hinge layer (170).

FIG. 9 schematically illustrates one of many possible micromirror devices. In other examples, the micromirror device may comprise a light transmissive substrate, such as glass, quartz, and sapphire, and a semiconductor substrate formed thereon an electronic circuit. The light transmissive substrate and the semiconductor substrate are disposed approximate to each other leaving a vertical gap therebetween. A reflective mirror plate is formed and disposed within the gap between the light transmissive and semiconductor substrates. In another example, the reflective mirror plate can be in the same plane of the light transmissive substrate and derived from the light transmissive substrate.

It will be appreciated by those of skill in the art that a new and useful non-specular reflective optical element and a system using the same have been described herein. In view of the many possible embodiments, however, it should be recognized that the embodiments described herein with respect to the drawing figures are meant to be illustrative only and should not be taken as limiting the scope of what is claimed. Those of skill in the art will recognize that the illustrated embodiments can be modified in arrangement and detail. Therefore, the devices and methods as described herein contemplate all such embodiments as may come within the scope of the following claims and equivalents thereof.

I claim:

1. An imaging system, comprising:
a light valve comprising an array of individually addressable pixels; and
a non-specular reflective optical element comprising a reflective surface disposed between the light valve and a display target for reflecting light from the light valve onto the display target.

2. The system of claim 1, wherein the reflective surface comprises:
a series of reflective facets, wherein adjacent reflective facets are connected by a connection area such that a normal direction of the connection area is substantially not parallel to a normal direction of either one of said adjacent reflective facets.

3. The system of claim 1, wherein the reflective facets are recess facets of the reflective surface.

4. The system of claim 1, wherein the reflective facets each are substantially flat and elongated along a direction that is substantially perpendicular to another direction along which the series of facets are deployed.

5. The system of claim 1, wherein the reflective facets each are curved and elongated along a direction that is substantially perpendicular to another direction along which the series of facets are deployed.

6. The system of claim 1, wherein the display target is a translucent screen on which the reflected light from the reflective surface is projected.

7. The system of claim 1, wherein the reflective facets are substantially periodically disposed along the reflective surface.

8. The system of claim 1, wherein at least two of the reflective facets have different reflective areas.

9. The system of claim 1, wherein the pixels of the light valve are reflective and deflectable micromirrors or liquid-crystal-on-silicon devices; and wherein the system further comprises: an illumination system for providing light.

10. The system of claim 9, wherein the illumination system further comprising: a laser source.

11. A projector, comprising:
a light valve comprising an array of individually addressable pixels; and
a reflective mirror disposed between the light valve and a display target, wherein the reflective mirror comprises a reflective surface for projecting light from the light valve onto the display target; and wherein the reflective surface comprises: a set of grooves each having a reflective facet.

12. The projector of claim 11, wherein the reflective facets are substantially parallel to each other.

13. The projector of claim 12, wherein the reflective facets each having a normal direction; and wherein the normal directions of the facets are substantially parallel.

14. The projector of claim 13, wherein each one of said adjacent reflective facets forms an angle to said connection area; and wherein said angle is not 0 or 180 degrees.

15. The projector of claim 11, wherein the reflective facets are substantially flat or curved.

16. The projector of claim 15, wherein the reflective facets are curved facets each having a positive or negative curvature.

17. A projector, comprising:
a light valve having an array of individually addressable pixels; and
a mirror disposed between the light valve and a display target, wherein the mirror comprises a Bragg grating such that a visible light beam incident to the mirror at an incident angle is capable of being reflected by the Bragg grating into a reflected light beam having a reflection angle that is different from the incident angle.

18. The projector of claim 17, wherein the mirror comprises a device substrate that is a non-crystal substrate.

19. The projector of claim 17, wherein the Bragg grating is on a surface or embedded within a body of a substrate of the mirror.

20. The projector of claim 17, further comprising:
a first Bragg grating for reflecting light with a first characteristic wavelength;
a second Bragg grating for reflecting light with a second characteristic wavelength.
